(19) United States
(12) Patent Application Publication
(10) Pub. No.: US 2006/0136273 A1
(43) Pub. Date: Jun. 22, 2006

(54) Method and system for estimating insurance loss reserves and confidence intervals using insurance policy and claim level detail predictive modeling

(76) Inventors: Frank Zizzamia, Avon, CT (US); Jan Lommele, West Hartford, CT (US); James Guszcza, Santa Monica, CA (US); John Lucker, Simsbury, CT (US); Peter Wu, Arcadia, CA (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/223,807

(22) Filed: Sep. 9, 2005

Related U.S. Application Data
(60) Provisional application No. 60/609,141, filed on Sep. 10, 2004.

(51) Int. Cl. G06F 17/10; G06Q 40/00

(52) U.S. Cl. 705/4; 703/2

(57) ABSTRACT

A computerized system and method for estimating insurance loss reserves and confidence intervals using insurance policy and claim level detail predictive modeling. Predictive models are applied to historical loss, premium and other insurer data, as well as external data, at the level of policy detail to predict ultimate losses and allocated loss adjustment expenses for a group of policies. From the aggregate of such ultimate losses, paid losses to date are subtracted to derive an estimate of loss reserves. Dynamic changes in a group of policies can be detected enabling evaluation of their impact on loss reserves. In addition, confidence intervals around the estimates can be estimated by sampling the policy-by-policy estimates of ultimate losses.

### CROSS REFERENCE TO RELATED APPLICATIONS

This application claims the benefit of U.S. Provisional Patent Application No. 60/609,141 filed on Sep. 10, 2004, the disclosures of which is incorporated herein by reference in its entirety.

### BACKGROUND OF THE INVENTION

The present invention is directed to a quantitative system and method that employ public external data sources (“external data”) and a company's internal loss data (“internal data”) and policy information at the policyholder and coverage level of detail to more accurately and consistently predict the ultimate loss and allocated loss adjustment expense (“ALAE”) for an accounting date (“ultimate losses”). The present invention is applicable to insurance companies, reinsurance companies, captives, pools and self-insured entities.

Estimating ultimate losses is a fundamental task for any insurance provider. For example, general liability coverage provides coverage for losses such as slip and fall claims. While a slip and fall claim may be properly and timely brought during the policy's period of coverage, actual claim payouts may be deferred over several years, as is the case where the liability for a slip and fall claim must first be adjudicated in a court of law. Actuarially estimating ultimate losses for the aggregate of such claim events is an insurance industry concern and is an important focus of the system and method of the present invention. Accurately relating the actuarial ultimate payout to the policy period's premium is fundamental to the assessment of individual policyholder profitability.

As discussed in greater detail hereinafter, “internal data” include policy metrics, operational metrics, financial metrics, product characteristics, sales and production metrics, qualitative business metrics attributable to various direct and peripheral business management functions, and claim metrics. The “accounting date” is the date that defines the group of claims in terms of the time period in which the claims are incurred. The accounting date may be any date selected for a financial reporting purpose. The components of the financial reporting period as of an accounting date referenced herein are generally “accident periods” (the period in which the incident triggering the claim occurred), the “report period” (the period in which the claim is reported), or the “policy period” (the period in which the insurance policy is written); defined herein as “loss period”.

Property/casualty insurance companies (“insurers”) have used many different methods to estimate loss and ALAE reserves. These methods are grounded in years of traditional and generally accepted actuarial and financial accounting standards and practice, and typically involve variations of three basic methods. The three basic methods and variations thereof described herein in the context of a “paid loss” method example involve the use of losses, premiums and the product of claim counts and average amount per claim.

The first basic method is a loss development method. Claims which occur in a given financial reporting period component, such as an accident year, can take many years to be settled. The valuation date is the date through which transactions are included in the data base used in the evaluation of the loss reserve. The valuation date may coincide with the accounting date or may be prior to the accounting date. For a defined group of claims as of a given accounting date, reevaluation of the same liability may be made as of successive valuation dates.

“Development” is defined as the change between valuation dates in the observed values of certain fundamental quantities that may be used in the loss reserve estimation process. For example, the observed dollars of losses paid associated with a claim occurring within a particular accident period often will be seen to increase from one valuation date to the next until all claims have been settled. The pattern of accumulating dollars represents the development of “paid losses” from which “loss development factors” are calculated. A “loss development factor” is the ratio of a loss evaluated as of a given age to its valuation as of a prior age. When such factors are multiplied successively from age to age, the “cumulative” loss development factor is the factor which projects a loss to the oldest age of development from which the multiplicative cumulation was initiated.

For the loss development method, the patterns of emergence of losses over successive valuation dates are extrapolated to project ultimate losses. If one-third of the losses are estimated to be paid as of the second valuation date, then a loss development factor of three is multiplied by the losses paid to date to estimate ultimate losses. The key assumptions of such a method include, but may not be limited to: (i) that the paid loss development patterns are reasonably stable and have not been changed due to operational metrics such as speed of settlement, (ii) that the policy metrics such as retained policy limits of the insurer are relatively stable, (iii) that there are no major changes in the mix of business such as from product or qualitative characteristics which would change the historical pattern, (iv) that production metrics such as growth/decline in the book of business are relatively stable, and (v) that the legal/judicial/social environment is relatively stable.

The second basic method is the claim count times average claim severity method. This method is conceptually similar to the loss development method, except that separate development patterns are estimated for claim counts and average claim severity. The product of the estimated ultimate claim count and the estimated ultimate average claim severity is estimated ultimate losses. The key assumptions of such a method are similar to those stated above, noting, for example, that operational metrics such as the definition of a claim count and how quickly a claim is entered into the system can change and affect patterns. Therefore, the method is based on the assumption that these metrics are relatively stable.

The third basic method is the loss ratio method. To estimate ultimate losses the premium corresponding to the policies written in the period corresponding to the component of the financial reporting period is multiplied by an “expected loss ratio” (which is a loss ratio based on the insurer's pricing methods and which represents the loss ratio that an insurer expects to achieve over a group of policies). For example, if the premium corresponding to policies written from 1/1/×× to 12/31/×× is $100 and the expected loss ratio is 70%, then estimated ultimate losses for such policies is $70. The key assumption in this method is that the expected loss ratio can reasonably be estimated, such as through pricing studies of how losses appear to be developing over time for a similar group of policies.

There are also variations of the foregoing basic methods for estimating losses such as, for example, using incurred losses versus paid losses to estimate loss development or combining methods such as the loss development method and the loss ratio method. The methods used to estimate ALAE are similar to those used to estimate losses alone and may include the combination of loss and ALAE, or ratios of ALAE to loss.

The conventional loss and ALAE reserving practices described above evolved from an historical era of pencil-and-paper statistics when statistical methodology and available computer technology were insufficient to design and implement scalable predictive modeling solutions. These traditional and generally accepted methods have not considerably changed or evolved over the years and are, today, very similar to historically documented and practiced methods. As a result, the current paid or incurred loss development and claim count-based reserving practices take as a starting-point a loss or claim count reserving triangle: an array of summarized loss or claim count information that an actuary or other loss reserving expert attempts to project into the future.

A common example of a loss reserving triangle is a “ten-by-ten” array of 55 paid loss statistics.

TABLE A

| | Age | | | | | | | | | |
|---|---|---|---|---|---|---|---|---|---|---|
| Year | 0 | 1 | 2 | 3 | 4 | 5 | 6 | 7 | 8 | 9 |
| 0 | C_{0, 0} | C_{0, 1} | C_{0, 2} | C_{0, 3} | C_{0, 4} | C_{0, 5} | C_{0, 6} | C_{0, 7} | C_{0, 8} | C_{0, 9} |
| 1 | C_{1, 0} | C_{1, 1} | C_{1, 2} | C_{1, 3} | C_{1, 4} | C_{1, 5} | C_{1, 6} | C_{1, 7} | C_{1, 8} | — |
| 2 | C_{2, 0} | C_{2, 1} | C_{2, 2} | C_{2, 3} | C_{2, 4} | C_{2, 5} | C_{2, 6} | C_{2, 7} | — | — |
| 3 | C_{3, 0} | C_{3, 1} | C_{3, 2} | C_{3, 3} | C_{3, 4} | C_{3, 5} | C_{3, 6} | — | — | — |
| 4 | C_{4, 0} | C_{4, 1} | C_{4, 2} | C_{4, 3} | C_{4, 4} | C_{4, 5} | — | — | — | — |
| 5 | C_{5, 0} | C_{5, 1} | C_{5, 2} | C_{5, 3} | C_{5, 4} | — | — | — | — | — |
| 6 | C_{6, 0} | C_{6, 1} | C_{6, 2} | C_{6, 3} | — | — | — | — | — | — |
| 7 | C_{7, 0} | C_{7, 1} | C_{7, 2} | — | — | — | — | — | — | — |
| 8 | C_{8, 0} | C_{8, 1} | — | — | — | — | — | — | — | — |
| 9 | C_{9, 0} | — | — | — | — | — | — | — | — | — |

The “Year” rows indicates the year in which a loss for which the insurance company is liable was incurred. The “Age” columns indicates how many years after the incurred date an amount is paid by the insurance company. C_{i,j} is the total dollars paid in calendar year (i+j) for losses incurred in accident year i.

Typically, loss reserving exercises are performed separately by line of business (e.g., homeowners' insurance vs. auto insurance) and coverage (e.g., bodily injury vs. collision). Therefore, loss reserving triangles such as the one illustrated in Table A herein typically contain losses for a single coverage.

The relationship between accident year, development age and calendar year bears explanation. The “accident year” of a claim is the year in which the claim occurred. The “development age” is the lag between the accident's occurrence and payment for the claim. The calendar year of the payment therefore equals the accident year plus the development age.

Suppose, for example, that “Year 0” in Table A is 1994. A claim that occurred in 1996 would therefore have accident year i=2. Suppose that the insurance company makes a payment of $1,000 for this claim j=3 years after the claim occurred. This payment therefore takes place in calendar year (i+j)=5, or in 1999. In summary, accident year plus development age (i+j) equals the calendar year of payment. It should be noted that this implies that the payments on each diagonal of the claim array fall in the same calendar year. In the above example, the payments C_{9,0}, C_{8,1}, . . . , C_{0,9}, all take place in calendar year 2003.

The payments along each row, on the other hand, represent dollars paid over time for all of the claims that occurred in a certain accident year. Continuing with the above example, the total dollars of loss paid by the insurance company for accident Year 1994 is:

$${L}_{0} = {\sum }_{j = 0}^{9} {C}_{0 , j}$$

It should be noted that this assumes that all of the money for accident Year 1994 claims is paid out by the end of calendar year 2003. An actuary with perfect foresight at December 1994 would have therefore advised that $R be set aside in reserves where:

$$R = {\sum }_{j = 1}^{9} {C}_{0 , j}$$

Similarly, given the earned premium associated with each policy by year, such premium can be aggregated to calculate a loss ratio which has emerged as of a given year. This “emerged loss ratio” (emerged losses divided by earned premium) can be calculated on either a paid loss or incurred loss basis, in combination with ALAE or separately.

The goal of a traditional loss reserving exercise is to use the patterns of paid amounts (“loss development patterns”) to estimate unknown future loss payments (denoted by dashes in Table A). That is, with reference to Table A, the aim is to estimate the sum of the unknown quantities denoted by dashes based on the “triangle” of 55 numbers. This sum may be referred to as a “point estimate” of the insurance company's outstanding losses as of a certain date.

A further goal, one that has been pursued more actively in the actuarial and regulatory communities in recent years, is to estimate a “confidence interval” around the point estimate of outstanding reserves. A “confidence interval” is a range of values around a point estimate that indicates the degree of certainty in the associated point estimate. A small confidence interval around the point estimate indicates a high degree of certainty for the point estimate; a large confidence interval indicates a low amount of certainty.

A loss triangle containing very stable, smooth payment patterns from Years 0-8 should result in a loss reserve estimate with a relatively small confidence interval; however a loss triangle with changing payment patterns and/or excessive variability in loss payments from one period or year to the next should result in a larger confidence interval. An analogy may help explain this. If the height of a 13 year-old's five older brothers all increased 12% between their 13^{th} and 14^{th} birthdays, there is a high degree of confidence that the 13 year-old in question will grow 12% in the coming year. Suppose, on the other hand, that the 13 year-old's older brothers grew 5%, 6%, 12%, 17% and 20%, respectively, between their 13^{th} and 14^{th} birthdays. In this case, the estimate would still be that the 13 year-old will grow 12% (the average of these five percentage increases) in the coming year. In both scenarios, the point estimate is 12%. However, in the second scenario, in which the historical data underlying the point estimate are highly variable, the confidence interval around this point estimate will be larger. In short, high variability in historical data translates into lower confidence on predictions based on that data.

There are several limitations with respect to commonly used loss estimation methods. First, as noted above, is the basic assumption in a loss based method that previous loss development patterns are indicative of future emergence patterns (stability). Many factors can affect emergence patterns such as, for example:

(i) changes in policy limits written, distribution by classification, or the specific jurisdiction or environment (policy metrics), (ii) changes in claim reporting or settlement patterns (operational metrics), (iii) changes in policy processing (financial metrics), (iv) changes in the mix of business by type of policy (product characteristics), (v) changes in the rate of growth or decline in the book of business (production metrics), (vi) claim metrics, and (vii) changes in the underwriting criteria to write a type of policy (qualitative metrics).

The difficulties surrounding the above limitations are compounded when aggregate level loss and premium data are used in the common methodologies. For example, it is generally recognized in actuarial science that increasing the limits on a group of policies will lengthen the time to settle losses on such policies, which, in turn, increases loss development. Similarly, writing business which increases claim severity, such as, for example, business in higher rated classifications or in certain tort environments, may also lengthen settlement time and increase loss development. Changes in operational metrics such as case reserve adequacy or speed of settlement also affect loss development patterns.

Second, with respect to aggregate level premiums and losses, the impact of financial metrics such as the rate level changes on loss ratio (the ratio of losses to premium for a component of the financial reporting period) can be difficult to estimate. This is, in part, due to assumptions which might be made at the accounting date on the proportion and quality of new business and renewal business policies written at the new rate level.

Subtle shifts in other metrics, such as policy metrics, operational metrics, product characteristics, production metrics, claim metrics or qualitative metrics of business written could have a potentially significant and disproportionate impact on the ultimate loss ratio underlying such business. For example, qualitative metrics are measured rather subjectively by a schedule of credits or debits assigned by the underwriter to individual policies. An example of a qualitative metric might be how conservative and careful the policyholder is in conducting his or her affairs. That is, all other things being equal, a lower loss ratio may result from a conservative and careful policyholder than from one who is less conservative and less careful. Also underlying these credits or debits are such non-risk based market forces as business pressures for product and portfolio shrinkage/growth, market pricing cycles and agent and broker pricing negotiations. Another example might be the desire to provide insurance coverage to a customer who is a valued client of a particular insurance agent who has directed favorable business to the insurer over time, or is an agent with whom an insurer is trying to develop a more extensive relationship.

One approach to estimating the impact of changes in financial metrics is to estimate such impacts on an aggregate level. For example, one could estimate the impact of a rate level change based on the timing of the change, the amount of the change by various classifications, policy limits and other policy metrics. Based on such impacts, one could estimate the impact on the loss ratio for policies in force during the financial reporting period.

Similarly, the changes in qualitative metrics could also be estimated at an aggregate level. However, none of the commonly used methods incorporates detailed policy level information in the estimate of ultimate losses or loss ratio. Furthermore, none of the commonly used methods incorporates external data at the policy level of detail.

A third limitation is over-parameterization. Intuitively, over-parameterization means fitting a model with more structure than can be reasonably estimated from the data at hand. By way of producing a point estimate of loss reserves, most common reserving methods require that between 10 and 20 statistical parameters are estimated. As noted above, the loss reserving triangle provides only 55 numbers, or data points, with which to estimate these 10-20 parameters. Such data-sparse, highly parameterized problems often lead to unreliable and unstable results with correspondingly low levels of confidence for the derived results (and, hence, a correspondingly large confidence interval).

A fourth limitation is model risk. Related to the above point, the framework described above gives the reserving actuary only a limited ability to empirically test how appropriate a reserving model is for the data. If a model is, in fact, over-parameterized, it might fit the 55 available data points quite well, but still make poor predictions of future loss payments (i.e., the 45 missing data points) because the model is, in part, fitting random “noise” rather than true signals inherent in the data.

Finally, commonly used methods are limited by a lack of “predictive variables.” “Predictive variables” are known quantities that can be used to estimate the values of unknown quantities of interest. The financial period components such as accident year and development age are the only predictive variables presented with a summarized loss array. When losses, claim counts, or severity are summarized to the triangle level, except for premiums and exposure data, there are no other predictive variables.

Generally speaking, insurers have not effectively used external policy-level data sources to estimate how the expected loss ratio varies from policy to policy. As indicated above, the expected loss ratio is a loss ratio based on the insurer's pricing methods and represents the loss ratio which an insurer expects to achieve over a group of policies. The expected loss ratio of a group of policies underlies that group's aggregate premiums, but the actual loss ratio would naturally vary from policy to policy. That is, many policies would have no losses, and relatively few would have losses. The propensity for a loss at the individual policy level and, therefore, the policy's expected loss ratio, is dependent on the qualitative characteristics of the policy, the policy metrics and the fortuitous nature of losses. Actuarial pricing methods often use predictive variables derived from various internal company and external data sources to compute expected loss and loss ratio at the individual policy level. However, analogous techniques have not been widely adopted in the loss reserving arena.

Accordingly, a need exists for a system and method that perform an estimated ultimate loss and loss ratio analysis at the level of the individual policy and claim level, and aggregate such detail to estimate ultimate losses, loss ratio and reserves for the financial reporting period as of an accounting date. An additional need exists for such a system and method that quantitatively include policyholder characteristics and other non-exposure based characteristics, including external data sources, to generate a generic statistical model that is predictive of future loss emergence of policyholders' losses, considering a particular insurance company's internal data, business practices and particular pricing methodology. A still further need exists for a scientific and statistical procedure to estimate confidence intervals from such data to better judge the reasonableness of a range of reserves developed by a loss reserving specialist.

In view of the foregoing, the present invention provides a new quantitative system and method that employ traditional data sources such as losses paid and incurred to date, premiums, claim counts and exposures, and other characteristics which are non-traditional to an insurance entity such as policy metrics, operational metrics, financial metrics, product metrics, production metrics, qualitative metrics and claim metrics, supplemented by data sources external to an insurance company to more accurately and consistently estimate the ultimate losses and loss reserves of a group of policyholders for a financial reporting period as of an accounting date.

### SUMMARY OF THE INVENTION

Generally speaking, the present invention is directed to a quantitative method and system for aggregating data from a number of external and internal data sources to derive a model or algorithm that can be used to accurately and consistently estimate the loss and allocated loss adjustment expense reserve (“loss reserve”), where such loss reserve is defined as aggregated policyholder predicted ultimate losses less cumulative paid loss and allocated loss adjustment expense for a corresponding financial reporting period as of an accounting date (“emerged paid loss”) and the incurred but not reported (“IBNR”) reserve which is the aggregated policyholder ultimate losses less cumulative paid and outstanding loss and allocated loss adjustment expense (“emerged incurred losses”) for the corresponding financial reporting period as of an accounting date. The phrase “outstanding losses” will be used synonymously with the phrase “loss reserves.” The process and system according to the present invention focus on performing such predictions at the individual policy or risk level. These predictions can then be aggregated and analyzed at the accident year level.

In addition, the system and method according to the present invention have utility in the development of statistical levels of confidence about the estimated ultimate losses and loss reserves. It should be appreciated that the ability to estimate confidence intervals follows from the present invention's use of non-aggregated, individual policy or risk level data and claim/claimant level data to estimate outstanding liabilities.

According to a preferred embodiment of the method according to the present invention, the following steps are effected: (i) gathering historical internal policyholder data and storing such historical policyholder data in a data base; (ii) identifying external data sources having a plurality of potentially predictive external variables, each variable having at least two values; (iii) normalizing the internal policyholder data relating to premiums and losses using actuarial transformations; (iv) calculating the losses and loss ratios evaluated at each of a series of valuation dates for each policyholder in the data base; (v) utilizing appropriate key or link fields to match corresponding internal data to the obtained external data and analyzing one or more external variables as well as internal data at the policyholder level of detail to identify significant statistical relationships between the one or more external variables, the emerged loss or loss ratio as of agej and the emerged loss or loss ratio as of age j+1; (vi) identifying and choosing predictive external and internal variables based on statistical significance and the determination of highly experienced actuaries and statisticians; (vii) developing a statistical model that (a) weights the various predictive variables according to their contribution to the emerged loss or loss ratio as of age j+1 (i.e., the loss development patterns) and (b) projects such losses forward to their ultimate level; (viii) if the model from step vii(a) is used to predict each policyholder's ultimate loss ratios, deriving corresponding ultimate losses by multiplying the estimated ultimate loss ratio by the policyholder's premium (generally a known quantity) from which paid or incurred losses are subtracted to obtain the respective loss and ALAE reserve or IBNR reserve; and (ix) using a “bootstrapping” simulation technique from modern statistical theory, re-sampling the policyholder-level data points to obtain statistical levels of confidence about the estimated ultimate losses and loss reserves.

The present invention has application to policy or risk-level losses for a single line of business coverage.

There are at least two approaches to achieving step vii(a) above. First, a series of predictive models can be built for each column in Table A. The target variable is the loss or loss ratio at age j+1; a key predictive variable is the loss or loss ratio at age j. Other predictive variables can be used as well. Each column's predictive model can be used to predict the loss or loss ratio values corresponding to the unknown, future elements of the loss array.

Second, a “longitudinal data” approach can be used, such that each policy's sequence of loss or loss ratio values serves as a time-series target variable. Rather than building a nested series of predictive models as described above, this approach builds a single time-series predictive model, simultaneously using the entire series of loss or loss ratio evaluations for each policy.

Step vii(a) above accomplishes two principal objectives. First, it provides a ratio of emerged losses from one year to the next at each age j. Second, it provides an estimate of the loss development patterns from age j to age j+1. The importance of this process is that it explains shifts in the emerged loss or loss ratio due to policy, qualitative and operational metrics while simultaneously estimating loss development from age j to age (j+1). These estimated ultimate losses are aggregated to the accident year level; and from this quantity the aggregated paid loss or incurred loss is subtracted. Thus, estimates of the total loss reserve or the total IBNR reserve, respectively, are obtained.

Accordingly, it is an object of the present invention to provide a computer-implemented, quantitative system and method that employ external data and a company's internal data to more accurately and consistently predict ultimate losses and reserves of property/casualty insurance companies.

Still other objects and advantages of the invention will in part be obvious and will in part be apparent from the specification.

The present invention accordingly comprises the various steps and the relation of one or more of such steps with respect to each of the others and the system embodies features of construction, combinations of elements and arrangement of parts which are adapted to effect such steps, all as exemplified in the following detailed disclosure and the scope of the invention will be indicated in the claims.

### BRIEF DESCRIPTION OF THE DRAWINGS

For a fuller understanding of the invention, reference is made to the following description, taken in connection with the accompanying drawings, in which:

FIGS. 1A and 1B are flow diagrams depicting process steps preparatory to generating a statistical model predictive of ultimate losses in accordance with a preferred embodiment of the present invention;

FIGS. 2A-2C are flow diagrams depicting process steps for developing a statistical model and predicting ultimate losses at the policyholder and claim level using the statistical model in accordance with a preferred embodiment of the present invention, as well as the process step of sampling policyholder data to obtain statistical levels of confidence about estimated ultimate losses and loss reserves in accordance with a preferred embodiment of the present invention;

FIG. 3 shows a representative example of statistics used to evaluate the statistical significance of predictive variables in accordance with a preferred embodiment of the present invention;

FIG. 4 depicts a correlation table which can be used to identify pairs of predictor variables that are highly correlated with one another in accordance with a preferred embodiment of the present invention; and

FIG. 5 is a diagram of a system in accordance with a preferred embodiment of the present invention.

### DETAILED OF THE PREFERRED EMBODIMENTS

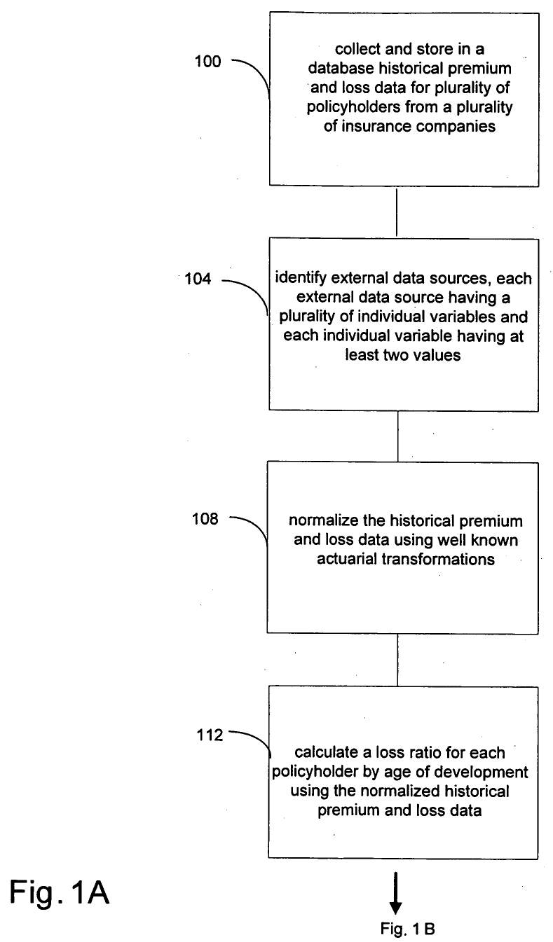

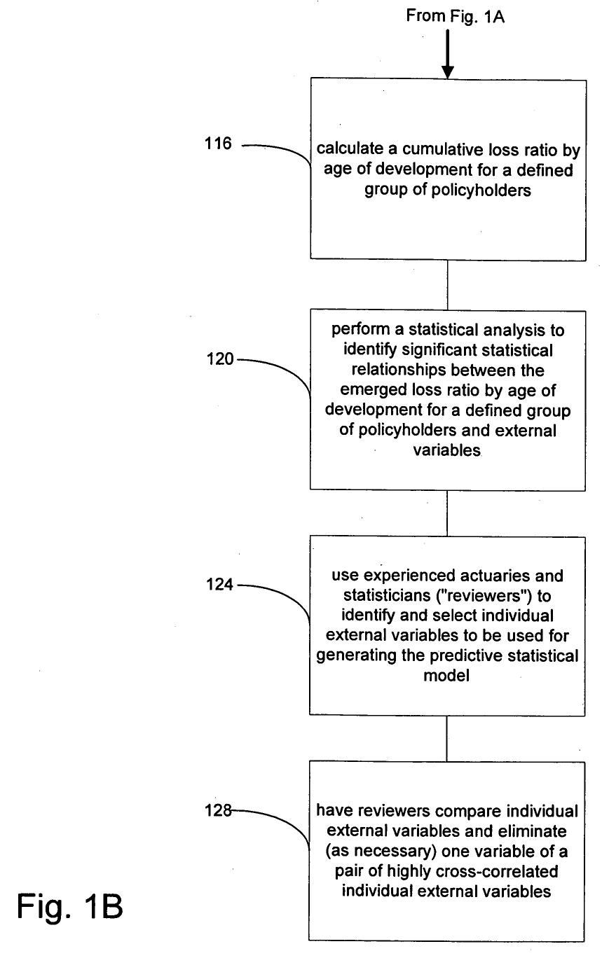

Reference is first made to FIGS. 1A and 1B which generally depict the steps in the process preparatory to gathering the data from various sources, actuarially normalizing internal data, utilizing appropriate key or linkage values to match corresponding internal data to the obtained external data, calculating an emerged loss ratio as of an accounting date and identifying predictive internal and external variables preparatory to developing a statistical model that predicts ultimate losses in accordance with a preferred embodiment of the present invention.

To begin the process at step 100, insurer loss and premium data at the policyholder and claim level of detail are compiled for a policyholder loss development data base. The data can include policyholder premium (direct, assumed, and ceded) for the term of the policy. A premium is the money the insurer collects in exchange for insurance coverage. Premiums include direct premiums (collected from a policyholder), assumed premiums (collected from another insurance company in exchange for reinsurance coverage) and “ceded” premiums (paid to another insurance company in exchange for reinsurance coverage). The data can also include (A) policyholder demographic information such as, for example, (i) name of policyholder, (ii) policy number, (iii) claim number, (iv) address of policyholder, (v) policy effective date and date the policy was first written, (vi) line of business and type of coverage, (vii) classification and related rate, (viii) geographic rating territory, (ix) agent who wrote the policy, (B) policyholder metrics such as, for example, (i) term of policy, (ii) policy limits, (iii) amount of premium by coverage, (iv) the date bills were paid by the insured, (v) exposure (the number of units of insurance provided), (vi) schedule rating information, (vii) date of claim, (viii) report date of claim, (ix) loss and ALAE payment(s) date(s), (x) loss and ALAE claim reserve change by date, (xi) valuation date (from which age of development is determined), (xii) amount of loss and ALAE paid by coverage as of a valuation date by claim (direct, assumed and ceded), (xiii) amount of incurred loss and ALAE by coverage as of a valuation date by claim (direct, assumed and ceded), and (xiv) amount of paid and incurred allocated loss adjustment expense or (DCA) expense as of a valuation date (direct, assumed and ceded), (C) claim demographic information such as claim number and claimant information, and (D) claim metrics such as time of day of incident, line of business and applicable coverage, nature of injury or loss (for example bodily injury vs. property damage vs. fire), type of injury or loss (for example, burn, fracture) cause of injury or loss diagnosis and treatment codes, and attorney involvement.

Next, in step 104, a number of external data sources having a plurality of variables, each variable having at least two values, are identified for use in appending the data base and for generating the predictive statistical model. Examples of external data sources include the CLUE data base of historical homeowners claims; the MVR (Motor Vehicle Records) data base of historical motor claims and various data bases of both personal and commercial financial stability (or “credit”) information. Synthetic variables are developed which are a combination of two or more data elements, internal or external, such as a ratio of weighted averages.

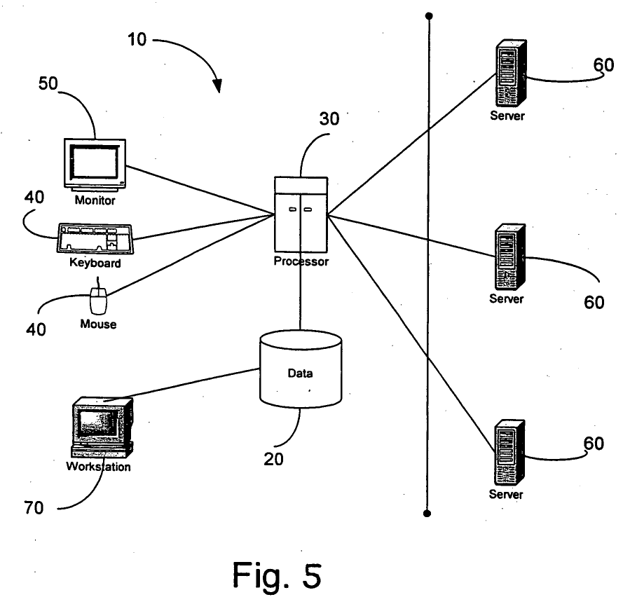

Referring to FIG. 5, all collected data, including the internal data, may be stored in a relational data base 20 (as are well known and provided by, for example, IBM, Microsoft Corporation, Oracle and the like) associated with a computer system 10 running the computational hardware and software applications necessary to generate the predictive statistical model. The computer system 10 preferably includes a processor 30, memory (not shown), storage medium (not shown), input devices 40 (e.g., keyboard, mouse) and display device 50. The system 10 may be operated using a conventional operating system and preferably includes a graphical user interface for navigating and controlling various computational aspects of the present invention. The system 10 can also be linked to one or more external data source servers 60. A stand-alone workstation 70, including a processor, memory, input devices and storage medium, can also be used to access the data base 20.

Referring back to FIG. 1A, in step 108, the policyholder premium and loss data are normalized using actuarial transformations. The normalized data (“work data”) including normalized premium data (“premium work data”) and normalized loss data (“loss work data”) are associated with the data sources to help identify external variables predictive of ultimate losses.

In step 112, the normalized loss and loss ratio that have emerged as of each relevant valuation date are calculated for each policy. The data are aggregated by loss period to determine the relative change in aggregate emerged loss or loss ratio from one valuation age to the next. That is, each policy's losses are aggregated by accident year and age of development. For example, if policy k had a claim or claims which occurred in accident year i, the losses recorded by accident year i at age j=0 would be the losses as they emerged in the first twelve months from the date of occurrence. The losses for that same accident year at age j=1, that is, in the next 12 months of development, would be the aggregate of losses occurring in accident year i as of age j=1. For paid losses, the aggregate equals the sum of all losses paid for claims reported in accident year i through age j=0, 1. For incurred losses, it equals the sum of all losses paid for claims reported for accident year i through age j=0, 1 plus the outstanding reserve at the end of the age j=1. This aggregation is done policy-by-policy across accident year and valuation dates.

In step 116, a cumulative loss and loss ratio is then calculated by age of development for a defined group of policyholders.

In step 120 the internal and external data are analyzed for their predictive statistical relationship to the normalized emerged loss ratio. For example, internal data such as the amount of policy limit or the record of the policyholder's bill paying behavior or combination of internal data variables may be predictive of ultimate losses by policy. Likewise, external data such as weather data, policyholder financial information, the distance of the policyholder from the agent, or combination of these variables may be predictive of ultimate losses by policy. It should be noted that, in all cases, predictions are based on variable values that are historical in nature and known at the time the prediction is being made.

In step 124 predictive internal and external variables are identified and selected based on their statistical significance and the determination of highly experienced actuaries and statisticians. Taking a linear model such as Cᵢⱼ=a+bX₁+cX₂ for example, there are standard statistical tests to evaluate the significance of predictive variables X₁, which could represent an internal data variable and X₂, which could represent an external data variable. These tests include the F and t statistics for X₁ and X₂, as well as the overall R² statistic, which represents the proportion of variation in the loss data explained by the model.

After the individual external variables have been selected by the analyst as being significant, these variables are examined by the analyst in step 128 against one another for cross-correlation. To the extent cross-correlation is present between, for example, a pair of external variables, the analyst may elect to discard one external variable of the pair of external variables showing cross-correlation.

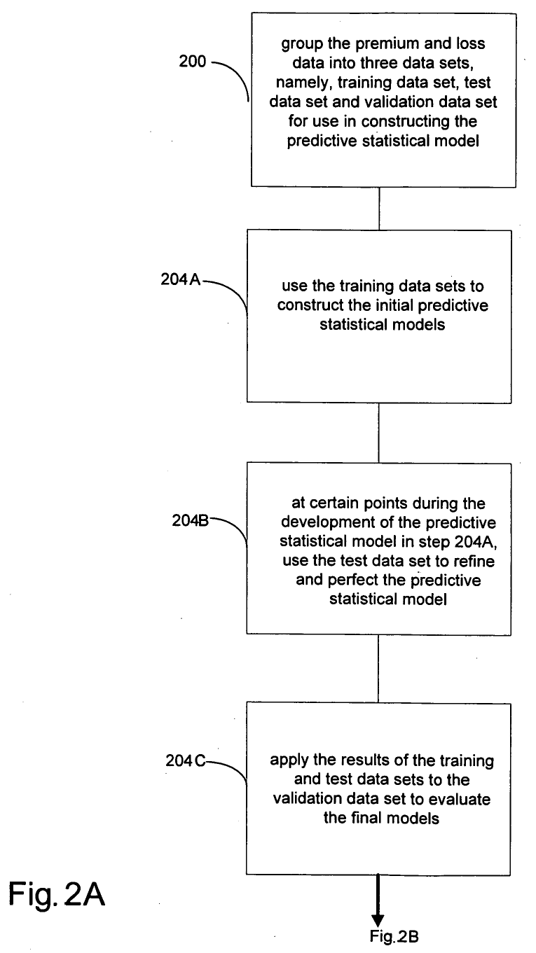

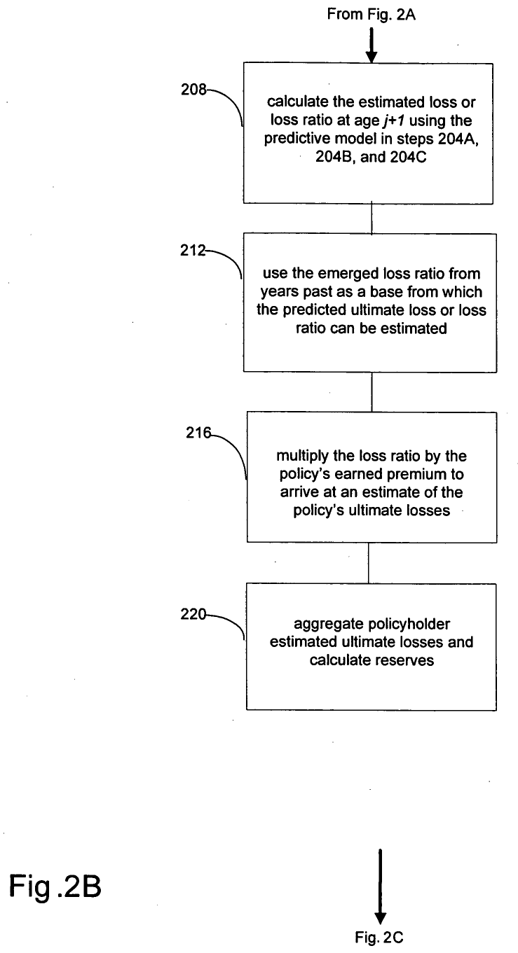

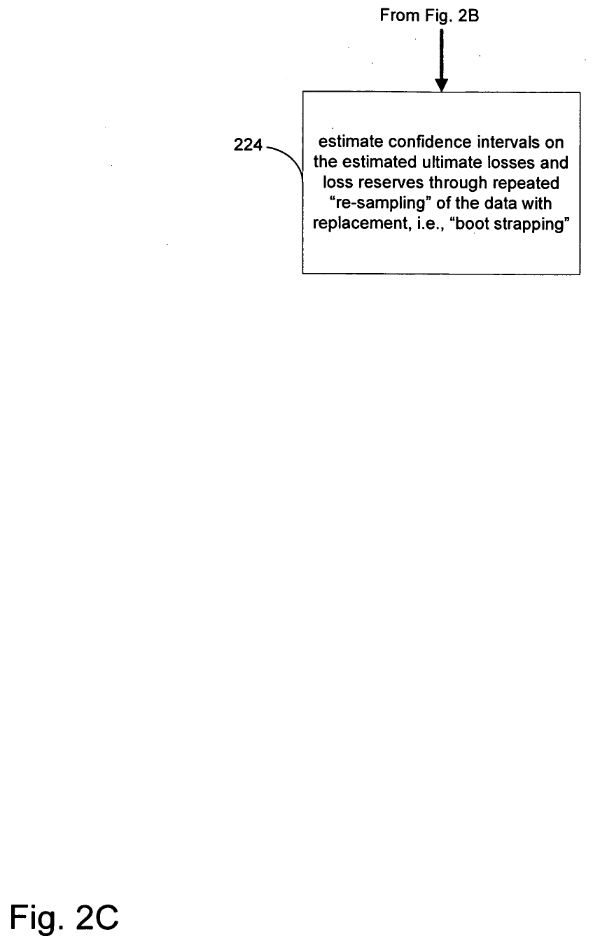

Referring now to FIGS. 2A and 2B, the steps in the process for generating the predictive statistical model based on internal and external data are generally depicted. In step 200, the data are split into multiple separate subsets of data on a random or otherwise statistically significant basis that is actuarially determined. More specifically, the data are split into a training data set, test data set and validation data set. The training data set includes the data used to statistically estimate the weights and parameters of a predictive model. The test data set includes the data used to evaluate each candidate model. Namely, the model is applied to the test data set and the emerged values predicted by the model are compared to the actual target emerged values in the test data set. The training and test data sets are thus used in an iterative fashion to evaluate a plurality of candidate models. The validation data set is a third data set held aside during this iterative process and is used to evaluate the final model once it is selected.

Partitioning the data into training, test and validation data sets is essentially the last step before developing the predictive statistical model. At this point, the premium and loss work data have been calculated and the variables predictive of ultimate losses have been initially defined.

The actual construction of the predictive statistical model involves steps 204A and 204B, as shown in FIG. 2A. More particularly, in step 204A, the training data set is used to produce initial statistical models. Having used the training data set to develop “k” models of the form cₖ=aₖ+bx₁ₖ+cx₂ₖ+ . . . , the various models are applied to the test data set to evaluate each candidate model. The models which could be based on incurred loss and/or ALAE data, paid loss and/or ALAE data, or other types of data are applied to the test data set and the emerged values predicted by the models are compared to the actual emerged target values in the test data set. In so doing, the training and test data sets are used iteratively to select the best candidate model(s) for their predictive power. The initial statistical models contain coefficients for each of the individual variables in the training data, that relate those individual variables to emerged loss or loss ratio at age j+1, which is represented by the loss or loss ratio of each individual policyholder's record in the training data base. The coefficients represent the independent contribution of each of the predictor variables to the overall prediction of the dependent variable, i.e., the policyholder emerged loss or loss ratio.

In step 204B, the testing data set is used to evaluate whether the coefficients from step 204A reflect intrinsic and not accidental or purely stochastic, patterns in the training data set. Given that the test data set was not used to fit the candidate model and given that the actual amounts of loss development are known, applying the model to the test data set enables one to evaluate actual versus predicted results and thereby evaluate the efficacy of the predictive variables selected to be in the model being considered. In short, performance of the model on test (or “out-of-sample”) data helps the analyst determine the degree to which a model explains true, as opposed to spurious, variation in the loss data.

In step 204C, the model is applied to the validation data set to obtain an unbiased estimate of the model's future performance.

In step 208, the estimated loss or loss ratio at age j+1 is calculated using the predictive statistical model constructed according to steps 204A, 204B and 204C. This model is applied to each record in the validation data set. More explicitly, suppose the model Cⱼ₊₁=β_{j+1,0}+β_{j+1,1}*X₁+βⱼ₊_{1,2}*X₂+β_{j+1,3}*X₃+ . . . is the model constructed to predict the value of each policy's loss, evaluated at period j+1. Each of the quantities {X₁, X₂, X₃, . . . } are predictive variables, the values of which are known. The β parameters were estimated as part of the model construction process and are therefore also known. Estimating the expected loss at age j+1 (Cⱼ₊₁) is therefore simply a matter of applying the above equation to these known quantities.

In step 212 the emerged loss or loss ratio from years past is used as a base from which the predicted ultimate losses or loss ratio can be estimated. The predicted loss ratio for a given year is equal to the sum of all actual losses emerged plus losses predicted to emerge at future valuation dates divided by the premium earned for that year.

In step 216 the loss ratio is then multiplied by the policy's earned premium to arrive at an estimate of the policy's ultimate losses.

In step 220 the policyholder ultimate losses are aggregated to derive policyholder estimated ultimate losses. From this quantity, cumulative aggregated paid loss or incurred loss is subtracted to obtain respective estimates of the total loss reserve or the total IBNR reserve.

In step 224 a technique known as bootstrapping is applied to the policy-level data base of estimated ultimate losses and loss reserves to obtain statistical levels of confidence about the estimated ultimate losses and loss reserves. Bootstrapping can be used to estimate confidence intervals in cases where no theoretically derived confidence intervals are available. Bootstrapping uses repeated “re-sampling” of the data, which is a type of simulation technique.

As indicated above and as will be explained in greater detail hereinafter, the task of developing the predictive statistical model is begun using the training data set. As part of the same process, the test data set is used to evaluate the efficacy of the predictive statistical model being developed with the training data set. The results from the test data set may be used at various stages to modify the development of the predictive statistical model. Once the predictive statistical model is developed, the predictiveness of the model is evaluated on the validation data set.

The steps as shown in FIGS. 1A, 1B, and 2A-2C are now described in more detail. In the preferred embodiment of the present invention, actual internal data for a plurality of policyholders are secured from the insurance company in step 100. Preferably, several years of policyholders' loss, ALAE and premium data are gathered and pooled together in a single data base of policyholder records. The data would generally be in an array of summarized loss or claim count information described previously as a loss triangle with corresponding premium for the year in which the claim(s) occurred. That is, for a given year i there are Nᵢ observations for an age of development. Relating observations of older years from early ages of development to later years of development provides an indication of how a less mature year might emerge from its respective earlier to later ages of development. This data base will be referred to as the “analysis file.”

Other related information on each policyholder and claim by claimant (as previously described in connection with step 100) is also gathered and merged onto the analysis file, e.g., the policyholder demographics and metrics, and claim metrics. This information is used in associating a policyholder's and claimant's data with the predictive variables obtained from the external data sources.

According to a preferred embodiment of the present invention in step 104, the external data sources include individual policy-level data bases available from vendors such as Acxiom, Choicepoint, Claritas, Marshall Swift Boeckh, Dun & Bradstreet and Experian. Variables selected from the policy-level data bases are matched to the data held in the analysis file electronically based on unique identifying fields such as the name and address of the policyholder.

Also included as an external data source, for example, are census data that are available from both U.S. Government agencies and third parties vendors, e.g., the EASI product. Such census data are matched to the analysis file electronically based on the policyholder's zip code. County level data are also available and can include information such as historical weather patterns, hail falls, etc. In the preferred embodiment of the present invention, the zip code-level files are summarized to a county level and the analysis file is then matched to the county-level data.

These data providers offer many characteristics of a policyholder's or claimant's household or business, e.g., income, home owned or rented, education level of the business owner, etc. The household-level data are based on the policyholder's or claimant's name, address, and when available, social security number. Other individual-level data sources are also included, when available. These include a policyholder's or claimant's individual credit report, driving record from MVR and CLUE reports, etc.

Variables are selected from each of the multiple external data sources and matched to the analysis file on a policy-by-policy basis. The variables from the external data sources are available to identify relationships between these variables and, for example, premium and loss data in the analysis file. As the statistical relationship between the variables and premium and loss data are established, these variables will be included in the development of a model that is predictive of insureds' loss development.

The matching process for the external data are completely computerized. Each individual external data base has a unique key on each of the records in the particular data base. This unique key also exists on each of the records in the analysis file. For external data, e.g., Experian or Dun & Bradstreet, the unique key is the business name and address. For the census data, the unique key is either the county code or the zip code. For business or household-level demographics, the unique key is either the business name or personal household address, or social security number.

The external data are electronically secured and loaded onto the computer system where the analysis file can be accessed. One or more software applications then match the appropriate external data records to the appropriate analysis file records. The resulting match produces expanded analysis file records with not only historical policyholder and claimant data but matched external data as well.

Next, in step 108, necessary and appropriate actuarial modifications to the data held in the analysis file are completed. Actuarial transformations are required to make the data more useful in the development of the predictive statistical model since much of the insurance company data within the analysis file cannot be used in its raw form. This is particularly true of the premium and loss data. These actuarial transformations include, but are not limited to, premium on-leveling to achieve a common basis of premium comparison, loss trending, capping and other actuarial techniques that may be relied on to accurately reflect the ultimate losses potential of each individual policyholder.

Premium on-leveling is an actuarial technique that transforms diversely calculated individual policyholder premiums to a common basis. This is necessary since the actual premium that a policyholder is charged is not entirely a quantitative, objective, or consistent process. More particularly, within any individual insurance company, premiums for a particular policyholder typically can be written by several “writing” companies, each of which may charge a different base premium. Different underwriters will often select different writing companies even for the same policyholder. Additionally, a commercial insurance underwriter may use credits or debits for individual policies further affecting the base premium. Thus, there are significant qualitative judgments or subjective elements in the process that complicate the determination of a base premium.

The premium on-leveling process removes these and other, subjective elements from the determination of the premium for every policy in the analysis file. As a result a common base premium may be determined. Such a common basis is required to develop the ultimate losses or loss ratio indications from the data that are necessary to build the predictive statistical model. For example, the application of schedule rating can have the effect of producing different loss ratios on two identical risks. Schedule rating is the process of applying debits or credits to base rates to reflect the presence or absence of risk characteristics such as safety programs. If schedule rating were applied differently to two identical risks with identical losses, it would therefore be the subjective elements which produce different loss ratios; not the inherent difference in the risk. Another example is that rate level adequacy varies over time. A book of business has an inherently lower loss ratio with a higher rate level. Two identical policies written during different timeframes at different rate adequacy levels would have a different loss ratio. Inasmuch as a key objective of the invention is to predict ultimate loss ratio, a common base from which the estimate can be projected is first established.

The analysis file loss data is actuarially modified or transformed according to a preferred embodiment of the present invention to produce more accurate ultimate loss predictions. More specifically, some insurance coverages have “long tail losses.” Long tail losses are losses that are usually not paid during the policy term, but rather are paid a significant amount of time after the end of the policy period.

Other actuarial modifications may also be required for the loss data. For example, very large losses could be capped since a company may have retentions per claim that are exceeded by the estimated loss. Also, modifications may be made to the loss data to adjust for operational changes.

These actuarial modifications to both the premium and loss data produce actuarially sound data that can be employed in the development of the predictive statistical model. As previously set forth, the actuarially modified data have been referred to as “work data,” while the actuarially modified premium and loss data have been referred to as “premium work data” and “loss work data,” respectively.

In related step 112, the loss ratio is calculated for each policyholder by age of development in the analysis file. As explained earlier, the loss ratio is defined as the numerical ratio of the loss divided by the premium. The emerged loss or loss ratio is an indication of an individual policy's ultimate losses, as it represents that portion of the premium committed to losses emerged to date.

In another aspect of the present invention, emerged “frequency” and “severity”, second important dimensions of ultimate losses, are also calculated in this step. Frequency is calculated by dividing the policy term total claim count by the policy term premium work data. Severity is calculated by dividing the policy term losses by the policy term emerged claim count. Although the loss ratio is the most common measure of ultimate losses, frequency and severity are important components of insurance ultimate losses.

The remainder of this invention description will rely upon loss ratio as the primary measurement of ultimate losses. But it should be correctly assumed that frequency and severity measurements of ultimate losses are also included in the development of the system and method according to the present invention and in the measurements of ultimate losses subsequently described herein.

Thereafter, in step 116 the loss ratio is calculated for a defined group. The cumulative loss ratio is defined as the sum of the loss work data for a defined group divided by the sum of the premium work data for the defined group. Typical definable groups would be based on the different insurance products offered. To calculate the loss ratio for an individual segment of a line of business all of the loss work data and premium work data for all policyholders covered by the segment of the line of business are subtotaled and the loss ratio is calculated for the entire segment of the line of business.

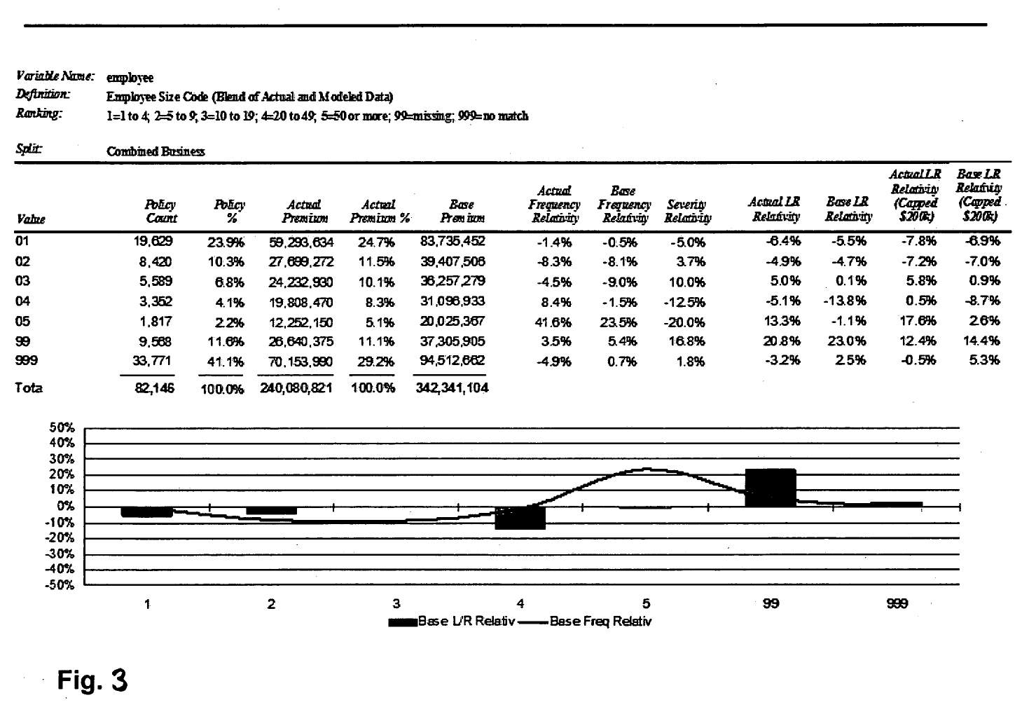

In step 120, a statistical analysis on all of the data in the analysis file is performed. That is, for each external variable from each external data source, a statistical analysis is performed that relates the effect of that individual external variable on the cumulative loss ratio by age of development. Well known statistical techniques such as multiple regression models may be employed to determine the magnitude and reliability of an apparent statistical relationship between an external variable and cumulative loss ratio. A representative example of statistics which can be calculated and reviewed to analyze the statistical significance of the predictor variables is provided in FIG. 3.

Each value that an external variable can assume has a loss ratio calculated by age of development which is then further segmented by a definable group (e.g., major coverage type). For purposes of illustration, the external variable of business-location-ownership might be used in a commercial insurance application (in which case the policyholder happens to be a business). Business-location-ownership is an external variable, or piece of information, available from Dun & Bradstreet. It defines whether the physical location of the insured business is owned by the business owner or rented by the business owner. Each individual variable can take on appropriate values. In the case of business-location-ownership, the values are O=owned and R=rented. The cumulative loss ratio is calculated for each of these values. For business owner location, the O value might have a cumulative loss ratio of 0.60, while the R value might have a cumulative loss ratio of 0.80, for example. That is, based on the premium work data and loss work data, owners have a cumulative loss ratio of 0.60 while renters have a cumulative loss ratio of 0.80, for example.

This analysis may then be further segmented by the major type of coverage. So, for business-owner-location, the losses and premiums are segmented by major line of business. The cumulative losses and loss ratios for each of the values O and R are calculated by major line of business. Thus, it is desirable to use a data base that can differentiate premiums and losses by major line of business.

In step 124, a review is made of all of the outputs derived from previous step 120. This review is based on human experience and expertise in judging what individual external variables available from the external data sources should be considered in the creation of the statistical model that will be used to predict the cumulative loss ratio of an individual policyholder.

In order to develop a robust system that will predict cumulative losses and loss ratio on a per policyholder basis, it is important to include only those individual external variables that, in and of themselves, can contribute to the development of the model (hereinafter “predictor variables”). In other words, the individual external variables under critical determination in step 124 should have some relationship to emerged loss and thus ultimate losses and loss ratio.

In the above example of business-location-ownership, it can be gleaned from the cumulative loss ratios described above, i.e., the O value (0.60) and the R value (0.80), that business-location-ownership may in fact be related to ultimate losses and therefore may in fact be considered a predictor variable.

As might be expected, the critical determination process of step 124 becomes much more complex as the number of values that an individual external variable might assume increases. Using a 40 year average hail fall occurrence as an example, this individual external variable can have values that range from 0 to the historical maximum, say 30 annual events, with all of the numbers in-between as possible values. In order to complete the critical determination of such an individual external variable, it is viewed in a particular manner conducive to such a critical determination, so that the highly experienced actuary and statistician can in fact make the appropriate critical determination of its efficacy for inclusion in the development of the predictive statistical model.

A common statistical method, called binning, is employed to arrange similar values together into a single grouping, called a bin. In the 40 year average hail fall individual data element example, ten bins might be produced, each containing 3 values, e.g., bin 1 equals values 0-3, bin 2 equals values 4-6 and so on. The binning process, as described, yields ten surrogate values for the 40 year average hail fall individual external variable. The critical determination of the 40 year average hail fall variable can then be completed by the experienced actuary and statistician.

The cumulative loss ratio of each bin is considered in relation to the cumulative loss ratio of each other bin and the overall pattern of cumulative loss ratios considered together. Several possible patterns might be discernable. If the cumulative loss ratio of the individual bins are arranged in a generally increasing or decreasing pattern, then it is clear to the experienced actuary and statistician that the bins and hence the underlying individual data elements comprising them, could in fact be related to commercial insurance emerged losses and therefore, should be considered for inclusion in the development of the statistical model.

Likewise, a saw toothed pattern, i.e., one where values of the cumulative loss ratio from bin to bin exhibit an erratic pattern when graphically illustrated and do not display any general direction trend, would usually not offer any causal relationship to loss or loss ratio and hence, would not be considered for inclusion in the development of the predictive statistical model. Other patterns, some very complicated and subtle, can only be discerned by the trained and experienced eye of the actuary or statistician, specifically skilled in this work. For example, driving skills may improve as drivers age to a point and then deteriorate from that age hence.

Thereafter in step 128, the predictor variables from the various external data sources that pass the review in prior step 124, are examined for cross correlations against one another. For example, suppose two different predictor variables, years-in-business and business-owners-age, are compared one to another. Since each of these predictor variables can assume a wide range of values, assume that each has been binned into five bins (as discussed above). Furthermore, assume that the cumulative loss ratio of each respective bin, from each set of five bins, is virtually the same for the two different predictor variables. In other words, years-in-business's bin 1 cumulative loss ratio is the same as business-owners-age's bin 1 cumulative loss ratio, etc.

This type of variable to variable comparison is referred to as a “correlation analysis.” In other words, the analysis is concerned with determining how “co-related” individual pairs of variables are in relation to one another.

All individual variables are compared to all other individual variables in such a similar fashion. A master matrix is prepared that has the correlation coefficient for each pair of predictor variables. The correlation coefficient is a mathematical expression for the degree of correlation between any pair of predictor variables. Suppose X₁ and X₂ are two predictive variables; let μ₁ and μ₂ respectively denote their sample average values; and let σ₁ and σ₂ respectively denote their sample standard deviations. The standard deviation of a variable X is defined as:
√[Σ(X−μₓ)²]
The correlation between X₁ and X₂ is defined as:
ρ₁₂=[Σ(X₁−μ₁)*(X₂−μ₂)]/[(σ₁*σ₂]
(The standard “sigma” symbol Σ represents summation over all records in the sample.) If there are N predictive variables X₁, X₂, . . . , X_{N} the correlation matrix is formed by quantities ρᵢⱼ where i and j range from 1 to N. It is a mathematical fact that ρᵢⱼ takes on a value between 0 and 1. A correlation of 0 means that the two variables are statistically independent; a correlation of 1 means that the two variables co-vary perfectly and are therefore interchangeable from a statistical point of view. The greater the correlation coefficient, the greater the degree of correlation between the pair of individual variables.

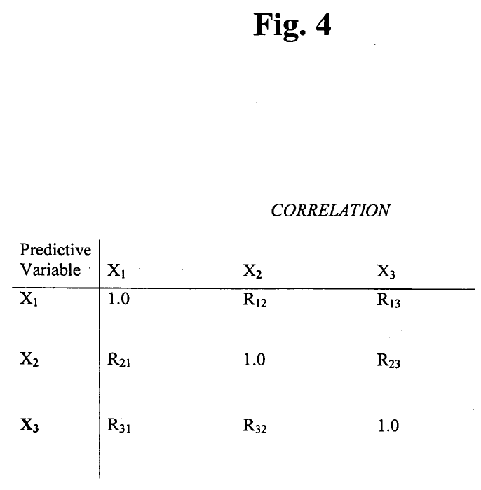

The experienced and trained actuary or statistician can review the matrix of correlation coefficients. The review can involve identifying those pairs of predictor variables that are highly correlated with one another (see e.g., the correlation table depicted in FIG. 4). Once identified, the real world meaning of each predictor variable can be evaluated. In the example above, the real world meaning of years-in-business and business-owner-age may be well understood. One reasonable causal explanation why this specific pair of predictive external variables might be highly correlated with one another would be that the older the business owner, the longer the business owner has been in business.

The experienced actuary or statistician then can make an informed decision to potentially remove one of the two predictor variables, but not both. Such a decision would weigh the degree of correlation between the two predictor variables and the real world meaning of each of the two predictor variables. For example, when weighing years in business versus the age of the business owner, the actuary or statistician may decide that the age of the business is more directly related to potential loss experience of the business because age of business may be more directly related to the effective implementations of procedures to prevent and/or control losses.

As shown in FIG. 2A, in step 200, the portion of the data base that passes through all of the above pertinent steps is subdivided into three separate data subsets, namely, the training data set, the testing data set and the validation data set. Different actuarial and statistical techniques can be employed to develop these three data sets from the overall data set. They include a random splitting of the data and a time series split. The time series split might reserve the most recent few years of historical data for the validation data set and the prior years for the training and testing data sets. Such a final determination is made within the expert judgment of the actuary and statistician.

1. Training Data Set

The development process to construct the predictive statistical model requires a subset of the data to develop the mathematical components of the statistical model. This subset of data are referred to as the “training data set.”

2. Testing Data Set

At times, the process of developing these mathematical components can actually exceed the true relationships inherent in the data and overstate such relationships. As a result, the coefficients that describe the mathematical components can be subject to error. In order to monitor and minimize the overstating of the relationships and hence the degree of error in the coefficients, a second data subset is subdivided from the overall data base and is referred to as the “testing data set.”

3. Validation Data Set The third subset of data, the “validation data set,” functions as a final estimate of the degree of predictiveness of ultimate losses or loss ratio that the mathematical components of the system can be reasonably expected to achieve on a go forward basis. Since the development of the coefficients of the predictive statistical model are influenced during the development process by the training and testing data sets, the validation data set provides an independent, non-biased estimate of the efficacy of the predictive statistical model.

The actual construction of the predictive statistical model involves steps 204A and 204B, as shown in FIG. 2A. More particularly, in step 204A, the training data set is used to produce an initial statistical model. The initial statistical model results in a mathematical equation, as described previously, that produces coefficients for each of the individual variables in the training data, that relate those individual variables to emerged loss or loss ratio at age j+1, which is represented by the loss or loss ratio of each individual policyholder's record in the training data base. The coefficients represent the independent contribution of each of the predictor variables to the overall prediction of the dependent variable, i.e., the policyholder emerged loss ratio.

Several different statistical techniques are employed in step 204A. Conventional multiple regression is the first technique employed. It produces an initial model. The second technique employed is generalized linear modeling. In some instances this technique is capable of producing a more precise set of coefficients than the multiple regression technique. A third technique employed is a type of neural network, i.e., backwards propagation of errors, or “backprop” for short. Backprop is capable of even more precise coefficients than generalized linear modeling. Backprop can produce nonlinear curve fitting in multi-dimensions and as such, can operate as a universal function approximator. Due to the power of this technique, the resulting coefficients can be quite precise and as such, yield a strong set of relationships to loss ratio. A final technique is the Multivariate Adaptive Regression Splines technique. This technique finds the optimal set of transformations and interactions of the variables used to predict loss or loss ratio. As such, it functions as a universal approximator like neural networks.

In step 204B, the testing data set is used to evaluate if the coefficients from step 204A have “overfit” the training data set. No data set that represents real world data is perfect; every such real world data set has anomalies and noise in the data. That is to say, statistical relationships that are not representative of external world realities. Overfitting can result when the statistical technique employed develops coefficients that not only map the relationships between the individual variables in the training set to ultimate losses, but also begin to map the relationships between the noise in the training data set and ultimate losses. When this happens, the coefficients are too fine-tuned to the eccentricities of the training data set. The testing data set is used to determine the extent of the overfitting.

In more detail, the model coefficients were derived by applying a suitable statistical technique to the training data set. The test data set was not used for this purpose. However, the resulting model can be applied to each record of the test data set. That is, the values Cⱼ for each record in the data set are calculated (Cⱼ denotes the model's estimate of loss evaluated at period j). For each record in the test data set, the estimated value of losses evaluated at j can be compared with the actual value of losses at j. For example, the mean absolute deviation (MAD) of the model estimates can be calculated from the actual values. The MAD is defined as the average of the absolute value of the difference between the actual value and the estimated value: MAD=AVG[|actual−estimated|].

For any model, the MAD can be calculated both on the data set used to fit the model (the training data set) and on any test data set. If a model produces a very low (i.e., “good”) MAD value on the training data set but a significantly higher MAD on the test data set, there is strong reason to suspect that the model has “over-fit” the training data. In other words, the model has fit idiosyncrasies of the training data that cannot be expected to generalize to future data sets. In information-theoretic terms, the model has fit too much of the “noise” in the data and perhaps not enough of the “signal”.

The method of fitting a model on a training data set and testing it on a separate test data set is a widely used model validation technique that enables analysts to construct models that can be expected to make accurate predictions in the future.

The model development process described in steps 204A (fitting the model on training data) and 204B (evaluating it on test data) is an iterative one. Many candidate models, involving different combinations of predictive variables and/or model techniques options, will be fit on the training data; each one will be evaluated on the test data. The test data evaluation offers a principled way of choosing a model that is the optimal trade-off between productiveness and simplicity. While a certain degree of model complexity is necessary to make accurate predictions, there may come a point in the modeling process where the addition of further additional variables, variable interactions, or model structure provides no marginal effectiveness (e.g., reduction in MAD) on the test data set. At this point, it is reasonable to halt the iterative modeling process.

When this iterative model-building process has halted, further assurance that the model will generalize well on future data is desirable. Each candidate model considered in the modeling process was fit on the training data and evaluated on the test data. Therefore, the test data were not used to fit a model. Still, the model performance on the test data (as measured by MAD or another suitable measure of model accuracy) might be overly optimistic. The reason for this is that the test data set was used to evaluate and compare models. Therefore, although it was not used to fit a model, it was used as part of the overall modeling process.

In order to provide an unbiased estimate of the model's future performance, the model is applied to the validation data set, as described in step 204C. This involves the same steps as applying the model to the test data set: the estimated value is calculated by inserting the (known) predictive variable values into the model equation. For each record, the estimated values are compared to the actual value and MAD (or some other suitable measure of model accuracy) is calculated. Typically, the model's accuracy measure deteriorates slightly in moving from the test data set to the validation data set. A significant deterioration might suggest that the iterative model-building process was too protracted, culminating in a “lucky fit” to the test data. However, such a situation can typically be avoided by a seasoned statistician with expertise in the subject-matter at hand.

By the end of step 204C, the final model has been selected and validated. It remains to apply the model to the data in order to estimate outstanding losses. This process is described in steps 208-220 (FIG. 2B). A final step, 224 (FIG. 2C), will use the modern simulation technique known as “bootstrapping” to estimate the degree of certainly (or “variance”) to be ascribed to the resulting outstanding loss estimate.

The modeling process has yielded a sequence of models (referred to hereinafter as “M₂, M₃ . . . , Mₖ”) that allow the estimation (at the policy and claim level) of losses evaluated at period 2, 3, . . . , k. In step 212, these models are applied to the data in a nested fashion in order to calculate estimated ultimate losses for each policy. More explicitly, model M₂ is applied to the combined data (train, test and validation combined) in order to calculate estimated losses evaluated at period 2. These period-2 estimated losses in turn serve as an input for the M₃ model; the period-3 losses estimated by M₃ in turn serve an input for M₄ and so on. The estimated losses resulting from the final model Mₖ are the estimated ultimate losses for each policy.

At this point, two considerations should be made. First, there will be cases in which the estimated losses arising from Mₖ are judged to be somewhat undeveloped despite the fact that the available data do not allow further extrapolation beyond period k. In such cases, a selected multiplicative “tail factor” can be applied to each policy to bring the estimated losses Cₖ to ultimate. This use of a tail factor (albeit on summarized data) is currently in accord with established actuarial practice.

Second, building and applying a sequence of models to estimate losses at period k has been described above—it is possible to use essentially the same methodology to estimate ultimate loss ratios (i.e. loss divided by premium) at period k. Either method is possible and justifiable; the analyst might prefer to estimate losses at k directly, since that is the quantity of interest. On the other hand, the analyst might prefer to work with loss ratios, deeming these quantities to be more stable and uniform across different policies. If the models M₂ . . . Mₖ have been constructed to estimate loss ratios evaluated at period k, these loss ratios for each policy are multiplied by that policy's earned premium to arrive at estimated losses. This is illustrated in step 216.

In step 220, the estimated ultimate losses are aggregated to the level of interest (either the whole book of business or to a sub-segment of interest). This gives an estimate of the total estimated ultimate losses for the chosen segment. From this the total currently emerged losses (paid or incurred, whichever is consistent with the ultimate losses that have been estimated) can be subtracted. The resulting quantity is an estimate of the total outstanding losses for the chosen segment of business.

At this point, the method described above yields an optimal estimate of total outstanding losses. But how much confidence can be ascribed to this estimate?

In more formal statistical terms, a confidence interval can be constructed around the outstanding loss estimate. Let L denote the outstanding loss estimate resulting from step 220. A 95%-confidence interval is a pair of numbers L₁ and L₂ with the two properties that (1) L₁, <L₂ and (2) there is a 95% chance that L falls within the interval (L₁,L₂). Other confidence intervals (such as 90% and 99%) can be similarly defined. The preferred way to construct a confidence interval is to estimate the probability distribution of the estimated quantity L. By definition, a probability distribution is a catalogue of statements “L is less than the value λ with probability Π.” Given this catalogue of statements it is straightforward to construct any confidence interval of interest.

Referring to FIG. 2C, step 224 illustrates estimating the probability distribution of estimate L of outstanding losses. A recently introduced simulation technique known as “bootstrapping” can be employed. The core idea of bootstrapping is sampling with replacement, also known a “resampling.” Intuitively, the actual population being studied can be treated as the “true” theoretical distribution. Suppose the data set used to produce a loss reserve estimate contains 1 million (1M) polices. Resampling this data set means randomly drawing 1M polices from the data set, each time replacing the randomly drawn policy. The data set can be resampled a large number of times (e.g., 1000 times). Any given policy might show up 0, 1, 2, 3, . . . times in any given resample. Therefore, each resample is a stochastic variant of the original data set.

The above method can be applied (culminating in step 220) to each of the 1000 resampled data sets. This yields 1000 outstanding loss reserve estimates L₁, . . . , L₁₀₀₀. These 1000 numbers constitute an estimate of the distribution of outstanding loss estimates, i.e., the distribution of L. As noted above, L can be used to construct a confidence interval around L. For example, let L_{5%} and L_{95%} denote the 5^{th} and 95^{th} percentiles respectively of the distribution L₁, . . . , L₁₀₀₀. These two numbers constitute a 90%-confidence interval around L (that is, L is between the values L_{5%} and L_{95%} with 90% probability 0.9). A small (or “tight”) confidence interval corresponds to a high degree of certainty in estimate L; a large (or “wide”) confidence interval corresponds to a low degree of certainty.

In accordance with the present invention, a computerized system and method for estimating insurance loss reserves and confidence intervals using insurance policy and claim level detail predictive modeling is provided. Predictive models are applied to historical loss, premium and other insurer data, as well as external data, at the level of policy detail to predict ultimate losses and allocated loss adjustment expenses for a group of policies. From the aggregate of such ultimate losses, paid losses to date can be subtracted to derive an estimate of loss reserves. A significant advantage of this model is to be able to detect dynamic changes in a group of policies and evaluate their impact on loss reserves. In addition, confidence intervals around the estimates can be estimated by sampling the policy-by-policy estimates of ultimate losses.

It will thus be seen that the objects set forth above, among those made apparent from the preceding description, are efficiently attained and, since certain changes can be made in carrying out the above method and in the constructions set forth for the system without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A computerized method for predicting ultimate losses of an insurance policy, comprising the steps of storing policyholder and claim level data including insurer premium and insurer loss data in a data base, identifying at least one external data source of external variables predictive of ultimate losses of said insurance policy, identifying at least one internal data source of internal variables predictive of ultimate losses of said insurance policy, associating said external and internal variables with said policyholder and claim level data, evaluating said associated external and internal variables against said policyholder and claim level data to identify individual ones of said external and internal variables predictive of ultimate losses of said insurance policy, and creating a predictive statistical model based on said individual ones of said external and internal variables.

2. The method of claim 1, further comprising the steps of creating individual records in said data base for individual policyholders and populating each of said records with premium and loss data, policyholder demographic information, policyholder metrics, claim metrics and claim demographic information.

3. The method of claim 2, wherein said step of associating said external and internal variables with said policyholder and claim level data includes associating at least one of said external and said internal variables with said individual records based on a unique key.

4. The method of claim 1, further comprising the step of normalizing said policyholder and claim level data.

5. The method of claim 4, wherein said step of normalizing said policyholder and claim level data is effected using actuarial transformations.

6. The method of claim 5, wherein said actuarial transformations include at least one of premium on-leveling, loss trending, and capping.

7. The method of claim 5, further comprising the steps of calculating a loss ratio by age of development based on said normalized policyholder and claim level data.

8. The method of claim 7, further comprising the steps of calculating frequency and severity measurements of ultimate losses.

9. The method of claim 7, further comprising the steps of defining a subgroup from said policyholder and claim level data and calculating a cumulative loss ratio by age of development for said subgroup.

10. The method of claim 9, further comprising the step of effecting a statistical analysis to identify statistical relationships between said loss ratio by age of development and said external and internal variables.

11. The method of claim 10, wherein said step of effecting a statistical analysis includes using multiple regression models.

12. The method of claim 1, wherein said at least one external data source includes external variables for business-level data and household-level data.

13. The method of claim 1, wherein said step of evaluating said associated external and internal variables against said policyholder and claim level data is effected using a binning statistical technique.

14. The method of claim 1, wherein said step of evaluating said associated external and internal variables against said policyholder and claim level data further includes the step of examining said external and internal variables for cross-correlation against one another and removing at least a portion of repetitive external and internal variables.

15. The method of claim 1, further comprising the step of dividing said data in said database into a training data set, a testing data set, and a validation data set.

16. The method of claim 15, further comprising the step of using said training data set and said test data set to iteratively generate an initial statistical model.

17. The method of claim 16, wherein said step of using said training data set and said test data set to generate an initial statistical model includes effecting at least one of multiple regression, linear modeling, backwards propagation of errors, and multivariate adaptive regression techniques.

18. The method of claim 17, wherein said step of using said testing data set includes iteratively refining said initial statistical model against overfitting.

19. The method of claim 18, further comprising the step of using said validation data set to evaluate the predictiveness of said initial statistical model.

20. The method of claim 19, further comprising the step of calculating an estimated loss ratio using said initial statistical model to yield said predictive statistical model.

21. The method of claim 20, further comprising the step of applying said predictive statistical model to said data in said data base to yield an estimate of ultimate losses.

22. The method of claim 21, further comprising the steps of aggregating estimated ultimate losses and calculating loss reserves.

23. The method of claim 22, further comprising the step of estimating confidence intervals on said estimated ultimate losses and said loss reserves using a bootstrapping simulation technique.

24. A system for predicting ultimate losses of an insurance policy, comprising a data base for storing policyholder and claim level data including insurer premium and insurer loss data, means for processing data from at least one external data source of external variables predictive of ultimate losses of said insurance policy and at least one internal data source of internal variables predictive of ultimate losses of said insurance policy, means for associating said external and internal variables with said policyholder and claim level data, means for evaluating said associated external and internal variables against said policyholder and claim level data to identify individual ones of said external and internal variables predictive of ultimate losses of said insurance policy, and means for generating a predictive statistical model based on said individual ones of said external and internal variables.

25. The system of claim 24, further comprising means for creating individual records in said data base for individual policyholders and means for populating each of said records with premium and loss data, policyholder demographic information, policyholder metrics, claim metrics and claim demographic information.

26. The system of claim 25, wherein said means for associating said external and internal variables with said policyholder and claim level data includes means for associating at least one of said external and internal variables with said individual records based on a unique key.

27. The system of claim 24, further comprising means for normalizing said policyholder and claim level data.

28. The system of claim 27, wherein said means for normalizing said policyholder and claim level data includes means for effecting actuarial transformations.

29. The system of claim 28, wherein said actuarial transformations include at least one of premium on-leveling, loss trending, and capping.

30. The system of claim 28, further comprising means for calculating a loss ratio by age of development based on said normalized policyholder and claim level data.

31. The system of claim 30, further comprising means for calculating frequency and severity measurements of ultimate losses.

32. The system of claim 30, further comprising means for defining a subgroup from said policyholder and claim level data and means for calculating a cumulative loss ratio by age of development for said subgroup.

33. The system of claim 32, further comprising means for effecting a statistical analysis to identify statistical relationships between said loss ratio by age of development and said external and internal variables.

34. The system of claim 33, wherein said means for effecting a statistical analysis includes means for utilizing multiple regression models.

35. The system of claim 24, wherein said at least one external data source includes external variables for business-level data and household-level data.

36. The system of claim 24, wherein said means for evaluating said associated external and internal variables against said policyholder and claim level data includes means for effecting a binning statistical technique.

37. The system of claim 24, further comprising means for dividing said data in said database into a training data set, a testing data set, and a validation data set.

38. The system of claim 37, further comprising means for iteratively generating an initial statistical model using said training data set and said testing data set.

39. The system of claim 38, wherein said means for iteratively generating an initial statistical model using said training data set and said testing data set includes means for effecting at least one of multiple regression, linear modeling, backwards propagation of errors, and multivariate adaptive regression techniques.

40. The system of claim 39, wherein said means for iteratively generating an initial statistical model using said training data set and said testing data set includes means for iteratively refining said initial statistical model against overfitting using said testing data set.

41. The system of claim 40, further comprising means for evaluating the predictiveness of said initial statistical model using said validation data set.

42. The system of claim 41, further comprising means for calculating an estimated loss ratio using said initial statistical model to yield said predictive statistical model.

43. The system of claim 42, further comprising means for applying said predictive statistical model to said data in said data base to yield an estimate of ultimate losses.

44. The system of claim 43, further comprising means for aggregating estimated ultimate losses and calculating loss reserves.

45. The system of claim 44, further comprising means for estimating confidence intervals on said estimated ultimate losses and said loss reserves including means for effecting a bootstrapping simulation technique.
